(19) United States
(12) Patent Application Publication
(10) Pub. No.: US 2020/0211422 A1
(43) Pub. Date: Jul. 2, 2020

(54) Processing Method of Address-Associated Data, User Terminal And Server

(71) Applicant: GUANGDONG CONSTRUCTION INFORMATION CENTER, Guangdong (CN)

(72) Inventors: Haitao YANG, Guangdong (CN); Sihan CHENG, Guangdong (CN); Zhenjiang RUAN, Guangdong (CN); Fei XU, Guangdong (CN)

(21) Appl. No.: 16/813,681

(22) Filed: Mar. 9, 2020

Related U.S. Application Data
(63) Continuation-in-part of application No. PCT/CN2018/076486, filed on Feb. 12, 2018.

(30) Foreign Application Priority Data
Sep. 20, 2017 (CN) 201710850892.8

(51) Int. Cl. G09B 29/10; G09B 29/00; G06T 5/00; G06T 7/11; G06F 16/29

(52) U.S. Cl. CPC G09B 29/106; G09B 29/003; G06T 2207/20021; G06T 7/11; G06F 16/29; G06T 5/009

(57) ABSTRACT

The present invention discloses a processing method of address-associated data, a user terminal and two servers, the method includes: transmitting a request for an electronic map to a map server (the first server); receiving the electronic map returned by the map server; selecting a region on the electronic map; transmitting a request for calculation of address-associated data on the region to an applied server (the second server); receiving a calculation result of the address-associated data on the region returned by the second server; and displaying the calculation result of the address-associated data on the region with the electronic map. This design and its implementation have significantly improved service response rate of processing and map-presenting massive address-associated data, hereby offered better user experience.

### CROSS REFERENCE TO RELATED APPLICATIONS

This application is a Continuation-In-Part of International Application No. PCT/CN2018/076486, filed on Feb. 12, 2018, which is based upon and claims priority to Chinese Patent Application No. 201710850892.8, filed on Sep. 20, 2017, the entire contents of which are incorporated herein by reference.

### TECHNICAL FIELD

The present invention relates to processing of address-associated data, and particularly to a processing method of address-associated data, a user terminal and a server.

### BACKGROUND

Address-associated data, also referred to as geographic data, is directly or indirectly associated with a certain location (address) relative to the earth, and serves as a document containing multiple factors of natural and social phenomena representing geographical location and distribution characteristics.

The address-associated data has found wide application. For example, a user can upload address-associated data to a remote server of a service provider for LBS (location-based service) after local collation, to be processed by this remote server and returned to the locality for presentation. However, there is usually a problem of low response rate and poor user experience due to massive data volume of address-associated data and limits in local computation power and network bandwidth, when processing massive address-associated data.

### SUMMARY

The technical problem to be addressed by embodiments of the present invention is low service response rate and poor user experience when processing massive address-associated data.

To this end, the embodiments of the present invention provide a processing method of address-associated data, including: transmitting a request for an electronic map to a first server; receiving the electronic map returned by the first server; selecting a region on the electronic map; transmitting a request for calculation of address-associated data on the region to a second server; receiving a calculation result of the address-associated data on the region returned by the second server; and displaying the calculation result of the address-associated data on the region with the electronic map. Optionally, the selecting a region on the electronic map includes: selecting a region by marking a rectangle, circle or polygon.

Optionally, the receiving a calculation result of the address-associated data on the region returned by the second server, includes: asynchronously receiving the calculation result of the address-associated data on the region; the displaying the calculation result of the address-associated data on the region includes: sequentially displaying the calculation result of the address-associated data on the region with the electronic map in the order of receipt.

Optionally, the second server stores address-associated data including the address-associated data of the region, the address-associated data stored on the second server are divided into multiple sets of address-associated data according to an indicator category; the displaying the calculation result of the address-associated data on the region with the electronic map, includes: displaying the calculation result in layers according to the indicator category, the steps of displaying the layers are independent of each other.

Optionally, the address-associated data stored on the second server are divided into corresponding multiple sets of address-associated data according to multi-group map scales; the calculation result of the address-associated data on the region includes a calculation result calculated according to the multi-group map scales; the displaying the calculation result of the address-associated data on the region includes: displaying the calculation result of the address-associated data on the region with the electronic map according to one map scale among the multi-group map scales.

The embodiments of the present invention also provide a processing method of address-associated data, including: receiving a request for calculation of address-associated data for a selected region transmitted by a user terminal; calculating the address-associated data for the selected region in a parallel distribution; transmitting calculation result of the address-associated data for the selected region to the user terminal.

The embodiments of the present invention also provide an electronic device, comprising:

at least one processor; and

a memory communicably connected with the at least one processor for storing instructions executable by the at least one processor, wherein execution of the instructions by the at least one processor causes the at least one processor to perform the step of:

transmitting a request for an electronic map to a first server;

receiving the electronic map returned by the first server;

selecting a region on the electronic map;

transmitting a request for calculation of address-associated data on the region to a second server;

receiving a calculation result of the address-associated data on the region returned by the second server; and

displaying the calculation result of the address-associated data on the region.

Optionally, the selecting a region on the electronic map comprises selecting a region by marking a rectangle, circle or polygon.

Optionally, the receiving a calculation result of the address-associated data on the region returned by the second server comprises asynchronously receiving the calculation result of the address-associated data on the region;

the displaying the calculation result of the address-associated data on the region comprises sequentially displaying the calculation result of the address-associated data on the region in the order of receipt.

Optionally, the second server stores address-associated data comprising the address-associated data of the region,

the address-associated data stored on the second server are divided into multiple sets of address-associated data according to an indicator category;

the displaying the calculation result of the address-associated data on the region comprises displaying the calculation result in layers according to the indicator category, and the steps of displaying the layers are independent of each other.

Optionally, the second server stores address-associated data comprising the address-associated data of the region,

the address-associated data stored on the second server are divided into corresponding multiple sets of address-associated data according to multi-group map scales;

the calculation result of the address-associated data on the region comprises results calculated according to the multi-group map scales;

the displaying of the calculation result of the address-associated data on the region comprises displaying the calculation result of the address-associated data on the region according to one of the multi-group map scales.

The embodiments of the present invention also provide two servers, including: a receiving unit, for receiving a request for calculation of address-associated data for a selected region transmitted by a user terminal; a calculation unit, for calculating the address-associated data for the region in a parallel distribution; and a transmission unit, for transmitting calculation result of the address-associated data for the region to the user terminal. According to the processing method of address-associated data, user terminal and server in the embodiments of the present invention, a user terminal is a capacity-limited device only required to transmit a request for calculation by powerful servers, did not locally process massive address-associated data, thus getting rid of local computation limit, and improving server's performance by classification and stage computation, and then boosting user experience.

### BRIEF DESCRIPTION OF THE DRAWINGS

Features and advantages of the present invention will be understood more clearly in reference to the accompanying figures, which are intended to make illustrations rather than impose any limits on the present invention, wherein:

FIG. 1 shows a diagram of application scenarios suitable for embodiments of the present invention;

FIG. 2 shows a structural diagram for a user terminal in an embodiment of the present invention;

FIG. 3 shows a structural diagram for a server in an embodiment of the present invention;

FIG. 4 shows a flow chart for a processing method of address-associated data in an embodiment of the present invention;

FIG. 5 shows a signalling flow chart for a processing method of address-associated data in an embodiment of the present invention;

FIG. 6 shows a structural diagram for a user terminal in an embodiment of the present invention;

FIG. 7 shows a structural diagram for a server in an embodiment of the present invention.

FIG. 8 shows a structural diagram for an electronic device in an embodiment of the present invention.

### DETAILED DESCRIPTION

In order to make the purpose, technical solutions and advantages in embodiments of the present invention clearer, the technical solutions in the embodiments of the present invention will be described as follows clearly and completely referring to figures accompanying the embodiments of the present invention, and surely, the described embodiments are just part rather than all embodiments of the present invention. Based on the embodiments of the present invention, all the other embodiments acquired by those skilled in the art without delivering creative efforts shall fall into the protection scope of the present invention.

FIG. 1 shows a diagram of application scenarios for embodiments of the present invention. The user terminal in the present invention is, for example, a mobile phone, a tablet computer or a desktop computer and other terminal equipment with a communication module, the first server is, for example, any LBS remote server capable of providing public electronic map service, the second server is, for example, a distributed parallel calculation server cluster capable of providing Web service. The user terminal is respectively connected to the first server and the second server via internet, regardless of wired connection or wireless connection. The user terminal and the second server are both provided with an application program or a software development kit (Software Development Kit, SDK) supporting the processing method of address-associated data of the present invention, and connection between the application program or SDK and the server adopts an HTTPS+XML interface protocol.

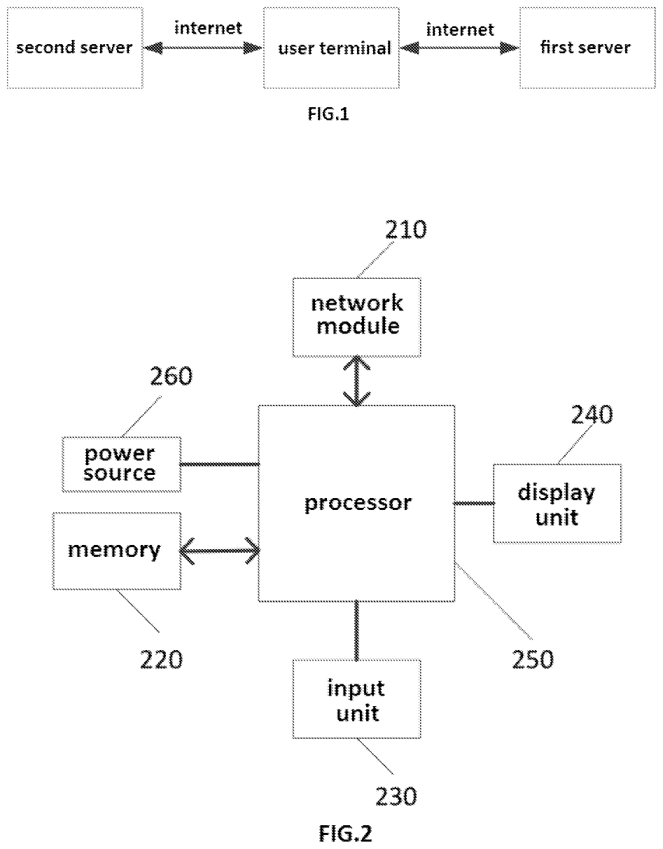

As an example, the user terminal is a desktop computer, and part of the structure for the desktop computer is shown in FIG. 2, including components, such as a network module 210, a memory 220, an input unit 230, a display unit 240, a processor 250, and a power source 260. Those skilled in the art may understand that, the structure shown in FIG. 2 does not constitute restrictions on the computer, and may include more or less components than those illustrated, or a combination of certain components, or different component arrangements.

The components of a desktop computer are to be detailed in conjunction with FIG. 2:

The network module 210 may be used for receiving and transmitting data, specifically, receiving downlink information before transmitting the information to the processor 260 for processing; and additionally, transmits uplink data to the first server or the second server.

The memory 220 may be used for storing software programs and modules. The processor 260 executes various functional applications as well as data processing of the desktop computer through operating software programs and modules stored on the memory 220. The memory 220 may mainly include a program storage section and a data storage section, wherein, the program storage section may store an operating system, at least application programs necessary for a function; the data storage section may store data created according to usage of the desktop computer. Moreover, the memory 220 may include high-speed random access memory, and may also include a non-volatile memory, for example, at least one of disk memory devices, flash devices, or other volatile solid-state memory devices.

The input unit 230 may be used for receiving inputted number or character information, and generating key signal input related to user settings and function control of the desktop computer. Specifically, the input unit 230 may include a touch panel and other input devices. Other input devices may include but not limited to one or more of physical keyboards, trackballs, mouse, levers, etc.

The display unit 240 may be used for displaying information inputted by or provided to the user. The display unit 240 may include a display panel, and optionally, may adopt a liquid crystal display (Liquid Crystal Display, LCD), an organic light emitting diode (Organic Light-Emitting diodes (OLED) and the like to configure the display panel.

The processor 250 serves as a control centre of the desktop computer, and performs various functions of the desktop computer and processes data by connecting all parts of desktop computer using various interfaces and circuits, running or executing software programs and/or modules stored in the memory 220, and calling data stored in the memory 220. Optionally, the processor 250 may include one or more processing units. The desktop computer also includes a power source 260 for powering each component, preferably, the power source may be logically connected to the processor 250 through a power source management system, thus realizing power consumption management and other functions.

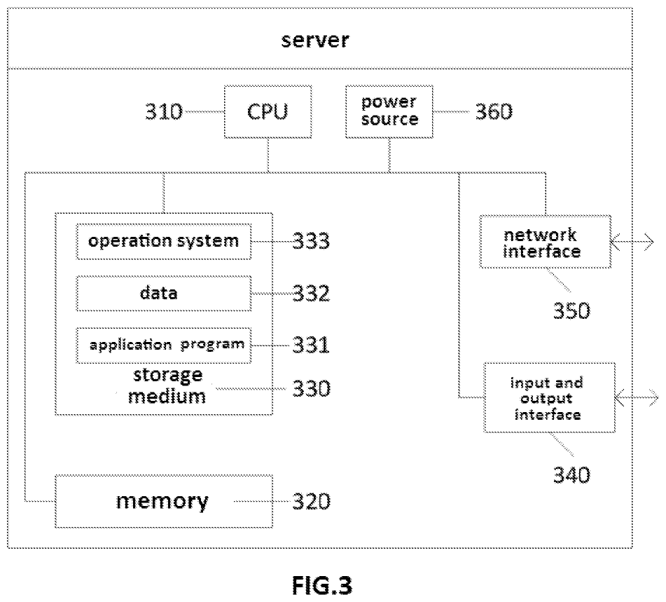

FIG. 3 shows a structural diagram for a server in an embodiment of the present invention. The server is, for example, the aforementioned second server, may vary wildly due to different configurations or performances, may include one or more central processors (CPU) 310 (for example, one or more processors), and a memory 320, one or more storage medium 330 for storing an application program 331 or data 332 (for example, one or more massive storage device), wherein, the memory 320 and the storage medium 330 may be used for transient or persistent storage. Programs stored in the storage medium 320 may include one or more modules (not indicated in the figures), each module may include a series of instructions for operations to the server. Furthermore, the CPU 310 may be configured to communicate with the storage medium 330, and to execute on the server a series of instructions for operations in the storage medium 330.

The server may also include one or more power sources 360, one or more network interfaces 350, one or more input-output interfaces 340, and/or one or more operating systems 333, for example, Windows Server™, Mac OS X™, Unix™, Linux™, FreeBSD™, etc.

The user terminal is connected to the network interface 350 of the server through the network module 210.

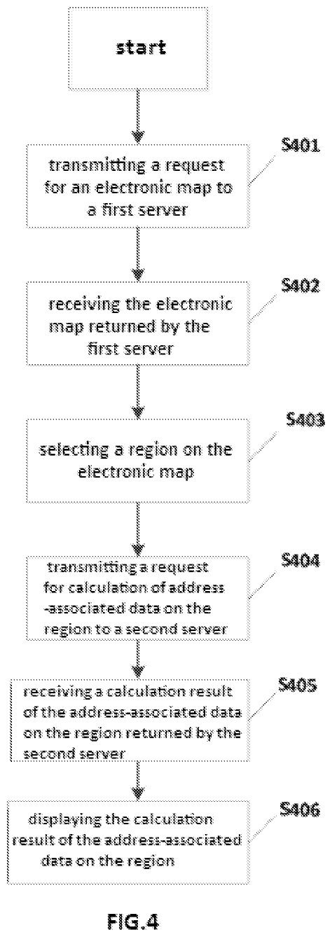

Referring to FIG. 4, an embodiment of the present invention provides a processing method of address-associated data, which is applicable to the user terminal, for example, a mobile phone, a tablet computer, a desktop computer or a laptop computer and the like, the processing method may specifically include:

S401: transmitting a request for an electronic map to a first server.

Specifically, the requested electronic map is, for example, data for a vector, satellite or three-dimensional slice map; the first server is, for example, an LBS remote server capable of providing public electronic map service;

S402: receiving the electronic map returned by the first server.

S403: selecting a region on the electronic map.

Specifically, a user may select to-be-calculated map region by marking factors such as a scope according to map scale. The user marking the scope may specifically include: selecting a region by marking a rectangle, circle or polygon;

S404: transmitting a request for calculation of address-associated data on the region to a second server. Specifically, what is transmitted is the request alone, without address-associated data of the region; the transmission may be conducted in an asynchronous manner; the request for calculation is, for example, one for heat clicks rendering of address-associated data on the region; the second server is, for example, a server cluster providing distributed parallel calculation of Web service;

S405: receiving a calculation result of the address-associated data on the region returned by the second server.

Specifically, the calculation result of the address-associated data on the region may be received asynchronously, so as to improve parallelism of the system; the calculation result is, for example, a heat map;

S406: displaying the calculation result of the address-associated data on the region. Specifically, the calculation result of the address-associated data on the region may be displayed sequentially in an order in which the data is received. Specifically, when the calculation result is a set of heat click rendered data, the set of heat click rendered data is compared with the map scale or the selection scope, so as to screen out a rendered data subset to be displayed, the subset is imparted with object elements for webpage heat clicks, then a universal webpage browser where the user terminal is located plots a corresponding heat symbol (patch) for each data for the heat click object elements on the page image. Optionally, the steps also include that the user terminal superposes statistics calculation result of a designated data indicator for the map region on the heat map, according to the map region selected by the user (in the form of a frame).

In the embodiments of the present invention, the user terminal is only required to transmit a request for calculation, without uploading address-associated data to a server terminal for calculation, thereby significantly improving response rate and boosting user experience.

Optionally, the second server stores address-associated data including the address-associated data of the region, the address-associated data stored on the second server are divided into multiple sets of address-associated data according to an indicator category, to reduce the scale demand for a single request for calculation; the step S406 may specifically include displaying the calculation result in layers according to the indicator category, and the steps of displaying the layers are independent of each other.

Optionally, the second server stores address-associated data including the address-associated data of the region, the address-associated data stored on the second server are divided into corresponding multiple sets of address-associated data according to multi-group map scales; the calculation result of the address-associated data on the region comprises calculation result calculated according to the multi-group map scales; the step S406 may specifically include: displaying the calculation result of the address-associated data on the region according to one map scale among the multi-group map scales.

As described above, a processing method of address-associated data in the present invention is described based on a user terminal, and for a better understanding, the processing method of address-associated data in the present invention will be described in detail based on the interactions among a user terminal, a first server and a second server.

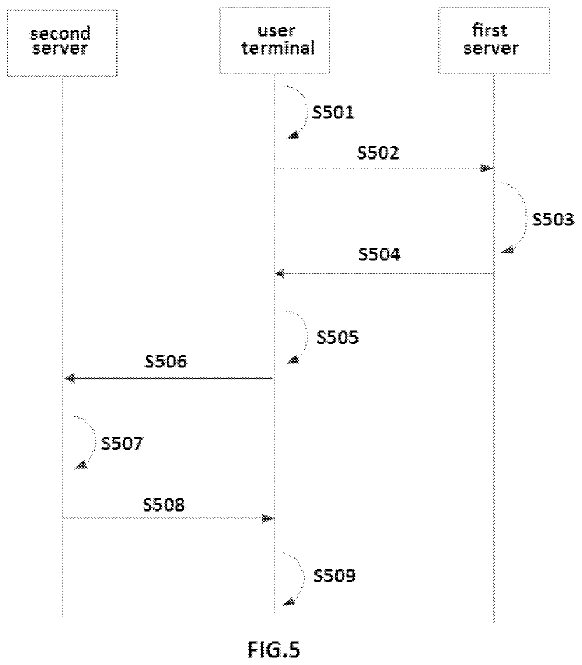

FIG. 5 shows a chart for signalling flow among a user terminal, a first server and a second server, with the user terminal respectively connected to the first server and the second server via internet.

The processing method of address-associated data in the present invention will be illustrated in conjunction with the signalling flow in FIG. 5:

S501: the user terminal acquires and configuration and operation data;

Specifically, the configuration data may be stored in a configuration document of the user terminal in advance, the contents thereof may include: default parameters (such as resolution ratio, display region, map slice type, etc.) presented by the electronic map, as well as user count information (such as authority) and other data; the operation data is set by a user during use via a user terminal interface, and includes designated data indicator categories (building area, time for construction, and located region), and data for the map scale or the selected scope.

S502: the user terminal transmits a request for an electronic map to the first server; specifically, the requested electronic map may be data for a vector, satellite or three-dimensional slice map;

The first server may be an LBS remote server capable of providing public electronic map service. S503: the first server collates the requested electronic map; S504: the first server returns the requested electronic map to the user terminal;

S505: the user terminal selects a region on the electronic map;

Specifically, the region on the electronic map to be calculated may be selected according to factors such as the page scale level or selected scope by the user.

S506: transmitting a request for calculation of address-associated data on the region to a second server;

Specifically, the second server is, for example, a server cluster for distributed parallel calculation capable of providing Web service, the second server stores address-associated data including the address-associated data of the region in advance.

S507: the second server calculates the requested address-associated data of the region; specifically, a CPU of the second server may initiate multiple distributed parallel processes to perform parallel calculation according to preset parameters according to the submitted request for calculation. Optionally, when the address-associated data has been divided into sets according to division factors and the calculation is intended to perform heat map rendering, the CPU may generate multiple mapping sub-processes as coordinate mapping (i.e., to map coordinate values into object elements on webpages of the browser) for each set of address-associated data according to demands for calculation, then generate one ordering sub-process, values of mapped data key value pairs are ordered by operation parameters submitted by the user terminal, and finally, the CPU performs heat click matching to the set of address-associated data according to the coordinates and attribute indexes (i.e., determines those data are integrated with the heat clicks).

S508: the second server returns the calculation result to the user terminal; specifically, the returning may be carried out asynchronously to the user terminal.

S509: the user terminal displays the calculation result. Specifically, when the calculation result is the result of heat map rendering, the heat click rendered data may be divided into sets according to the indicator category, electronic map scale or selected region, allowing rendered data of heat click to be drawn dynamically and cyclically set by set. Optionally, the sets of heat click rendered data may be displayed after all the sets are received or displayed as they are received.

The above embodiments introduce the processing method of address-associated data in the present invention, and the user terminal and the server will be described according to embodiments as follows.

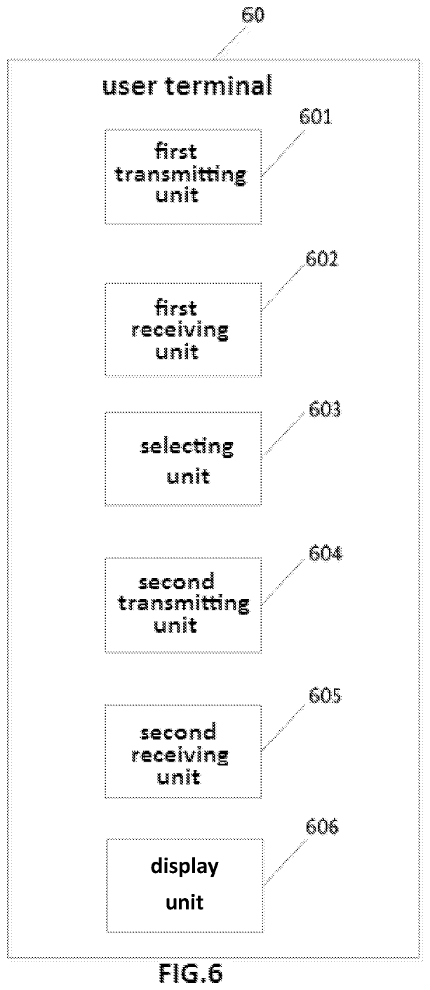

Referring to FIG. 6, an embodiment of the present invention provides a user terminal 60, including: a first transmitting unit 601, for transmitting a request for an electronic map to a first server; a first receiving unit 602, for receiving the electronic map returned by the first server; a selecting unit 603, for selecting a region on the electronic map; optionally, the region is selected by marking a rectangle, circle or polygon;

a second transmitting unit 604, transmitting a request for calculation of address-associated data on the region to a second server;

a second receiving unit 605, for receiving a calculation result of the address-associated data on the region returned by the second server; optionally, the calculation result is received asynchronously; and

a display unit 606, for displaying the calculation result of the address-associated data on the region; optionally, the calculation result of the address-associated data on the region is displayed sequentially in the order in which the data is received.

Optionally, when the second server stores address-associated data including the address-associated data of the region, the address-associated data stored on the second server are divided into multiple sets of address-associated data according to an indicator category; the display unit 606 is also used for displaying the calculation result in layers according to the indicator category, and the steps of displaying the layers are independent of each other.

The user terminal in the embodiments of the present invention is only required to transmit a request for calculation, without uploading address-associated data to a server terminal for calculation, thus greatly improving response rate and boosting user experience.

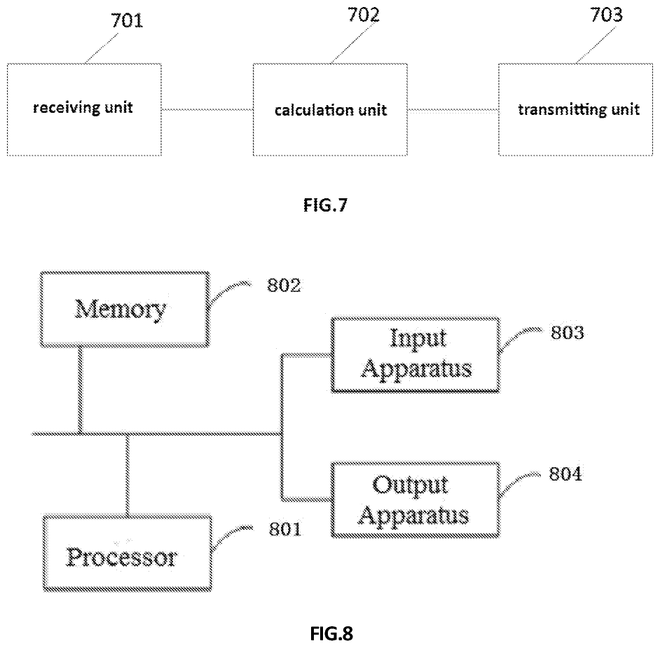

Referring to FIG. 7, an embodiment of the present invention provides a server, including:

a receiving unit 701, for receiving a calculation result of the address-associated data on a selected region transmitted by a user terminal;

a calculation unit 702, for calculating address-associated data of the region in parallel distribution manner; a transmission unit 703, for transmitting a calculation result of the address-associated data for selected region to the user terminal.

The server in the embodiments of the present invention stores address-associated data in advance, and calculates the selected address-associated data when receiving a request for calculation of the address-associated data for the selected region, thereby significantly improving response rate and boosting user experience.

FIG.8 is a schematic diagram of the hardware configuration of the electronic device provided by the embodiment, which performs the processing method of address-associated data. As shown in FIG. 8, the electronic device includes: one or more processors 801 and a memory 802, wherein one processor 801 is shown in FIG. 8 as an example. The electronic device that performs the processing method of address-associated data further includes an input apparatus 803 and an output apparatus 804.

The processor 801, the memory 802, the input apparatus 803 and the output apparatus 804 may be connected via a bus line or other means, wherein connection via a bus line is shown in FIG. 8 as an example.

The memory 802 is a non-transitory computer-readable storage medium that can be used to store non-transitory software programs, non-transitory computer-executable programs and modules, such as the program instructions/modules corresponding to the processing method of address-associated data of the embodiments of the present disclosure (e.g. a first transmitting unit 601, a first receiving unit 602, a selecting unit 603, a second transmitting unit 604, a second receiving unit 605, a display unit 606 shown in the FIG. 6). The processor 801 executes the non-transitory software programs, instructions and modules stored in the memory 802 so as to perform various function application and data processing of the server, thereby implementing the processing method of address-associated data of the above-mentioned method embodiments.

The memory 802 includes a program storage area and a data storage area, wherein, the program storage area can store an operation system and application programs required for at least one function; the data storage area can store data generated by use of the electronic device. Furthermore, the memory 802 may include a high-speed random access memory, and may also include a non-volatile memory, e.g. at least one magnetic disk memory unit, flash memory unit, or other non-volatile solid-state memory unit. In some embodiments, optionally, the memory 802 includes a remote memory accessed by the processor 801, and the remote memory is connected to the electronic device via network connection. Examples of the aforementioned network include but not limited to internet, intranet, LAN, GSM, and their combinations.

The input apparatus 630 receives digit or character information, so as to generate signal input related to the user configuration and function control of the electronic device. The output apparatus 640 includes display devices such as a display screen.

The one or more modules are stored in the memory 802 and, when executed by the one or more processors 801, perform the processing method of address-associated data of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:
a) Mobile communication devices: The characteristic of this type of device is having a mobile communication function with a main goal of enabling voice and data communication. This type of terminal device includes: smartphones (such as iPhone), multimedia phones, feature phones, and low-end phones.
b) Ultra-mobile personal computer devices: This type of device belongs to the category of personal computers that have computing and processing functions and usually also have mobile internet access features. This type of terminal device includes: PDA, MID, UMPC devices, such as iPad.
c) Portable entertainment devices: This type of device is able to display and play multimedia contents. This type of terminal device includes: audio and video players (such as iPod), handheld game players, electronic books, intelligent toys, and portable GPS devices.
d) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.
e) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

As described above, the embodiments are only intended to illustrate rather than limit the technical solutions of the present invention; although the present application is illustrated in detail with reference to the aforementioned embodiments, it should be understood by those of ordinary skill in the art that modifications may still be made to the technical solutions disclosed in the aforementioned respective embodiments, or equivalent substitutions may be made to part of technical characteristics thereof; and these modifications or substitutions shall not make the nature of the corresponding technical solutions depart from the scope of the technical solutions of the respective embodiments.

What is claimed is:

1. A processing method of address-associated data, comprising:
transmitting a request for an electronic map to a first server;
receiving the electronic map returned by the first server;
selecting a region on the electronic map;
transmitting a request for calculation of address-associated data on the region to a second server;
receiving a calculation result of the address-associated data on the region returned by the second server; and
displaying the calculation result of the address-associated data on the region.

2. The method of claim 1, wherein, the selecting a region on the electronic map comprises selecting a region by marking a rectangle, circle or polygon.

3. The method of claim 1, wherein,
the receiving a calculation result of the address-associated data on the region returned by the second server comprises asynchronously receiving the calculation result of the address-associated data on the region;
the displaying the calculation result of the address-associated data on the region comprises sequentially displaying the calculation result of the address-associated data on the region with the electronic map in the order of receipt.

4. The method of claim 1, wherein,
the second server stores address-associated data comprising the address-associated data of the region,
the address-associated data stored on the second server are divided into multiple sets of address-associated data according to an indicator category;
the displaying the calculation result of the address-associated data on the region comprises displaying the calculation result in layers according to the indicator category, and the steps of displaying the layers are independent of each other.

5. The method of any of claims 1, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying the calculation result of the address-associated data on the region comprises displaying the calculation result of the address-associated data on the region with the electronic map according to one of the multi-group map scales.

6. The method of any of claims 2, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying of the calculation result of the address-associated data on the region comprises displaying the calculation result of the address-associated data on the region according to one of the multi-group map scales.

7. The method of any of claims 3, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying of the calculation result of the address-associated data on the region comprises displaying the calculation result of the address-associated data on the region according to one of the multi-group map scales.

8. A processing method of address-associated data, comprising
receiving a request for calculation of address-associated data for a selected region transmitted by a user terminal;
calculating the address-associated data for the selected region in a parallel distribution manner;
transmitting calculation result of the address-associated data for the selected region to the user terminal.

9. An electronic device, comprising:
at least one processor; and
a memory communicably connected with the at least one processor for storing instructions executable by the at least one processor, wherein execution of the instructions by the at least one processor causes the at least one processor to perform the step of:
transmitting a request for an electronic map to a first server;
receiving the electronic map returned by the first server;
selecting a region on the electronic map;
transmitting a request for calculation of address-associated data on the region to a second server;
receiving a calculation result of the address-associated data on the region returned by the second server; and
displaying the calculation result of the address-associated data on the region.

10. The electronic device of claim 9, wherein, the selecting a region on the electronic map comprises selecting a region by marking a rectangle, circle or polygon.

11. The electronic device of claim 9, wherein,
the receiving a calculation result of the address-associated data on the region returned by the second server comprises asynchronously receiving the calculation result of the address-associated data on the region;
the displaying the calculation result of the address-associated data on the region comprises sequentially displaying the calculation result of the address-associated data on the region in the order of receipt.

12. The electronic device of claim 9, wherein,
the second server stores address-associated data comprising the address-associated data of the region,
the address-associated data stored on the second server are divided into multiple sets of address-associated data according to an indicator category;
the displaying the calculation result of the address-associated data on the region comprises displaying the calculation result in layers according to the indicator category, and the steps of displaying the layers are independent of each other.

13. The electronic device of claim 9, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying the calculation result of the address-associated data on the region comprises displaying the calculation result of the address-associated data on the region according to one of the multi-group map scales.

14. The electronic device of claim 10, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying the calculation result of the address-associated data on the region comprises displaying the calculation result of the address-associated data on the region according to one of the multi-group map scales.

15. The electronic device of claim 11, wherein,
the second server stores address-associated data comprising the address-associated data of the region,
the address-associated data stored on the second server are divided into corresponding multiple sets of address-associated data according to multi-group map scales;
the calculation result of the address-associated data on the region comprises calculation result calculated according to the multi-group map scales;
the displaying the calculation result of the address-associated data on the region comprises displaying the calculation result of the address-associated data on the region according to one of the multi-group map scales.
